(19) United States
(12) Patent Application Publication
(10) Pub. No.: US 2024/0181893 A1
(43) Pub. Date: Jun. 6, 2024

(54) METHOD OF IMPLEMENTING CHARACTERISTICS OF INTERNAL COMBUSTION ENGINE VEHICLE IN ELECTRIC VEHICLE

(71) Applicants: Hyundai Motor Company, Seoul (KR); Kia Corporation, Seoul (KR)

(72) Inventor: Ji Won OH, Hwaseong-Si (KR)

(73) Assignees: Hyundai Motor Company, Seoul (KR); Kia Corporation, Seoul (KR)

(21) Appl. No.: 18/134,891

(22) Filed: Apr. 14, 2023

(30) Foreign Application Priority Data
Dec. 2, 2022 (KR) 10-2022-0166612

(51) Int. Cl. B60L 15/20; B60Q 5/00

(52) U.S. Cl. CPC B60L 15/20; B60Q 5/008; B60L 2240/42; B60L 2270/42

(57) ABSTRACT

A method of implementing characteristics of an ICE vehicle in an EV, and configured for implementing a feeling of operation of a driving system and a feeling of driving of an ICE vehicle in an electric vehicle includes determining a virtual gear shifting type and starting virtual gear shifting, determining magnitude of a virtual effect while the virtual gear shifting is performed, determining an amount of correction of the magnitude of the virtual effect based on the virtual gear shifting type and state information related to the virtual gear shifting while the virtual gear shifting is performed, correcting the magnitude of the virtual effect by the amount of correction of the magnitude of the virtual effect while the virtual gear shifting is performed, and controlling an operation of a virtual effect generation device according to a virtual effect signal including the corrected magnitude of the virtual effect.

### CROSS-REFERENCE TO RELATED APPLICATION

The present application claims priority to Korean Patent Application No. 10-2022-0166612 filed on Dec. 2, 2022, the entire contents of which is incorporated herein for all purposes by this reference.

### BACKGROUND OF THE PRESENT DISCLOSURE

### Field of the Present Disclosure

The present disclosure relates to a method of implementing characteristics of an internal combustion engine vehicle in an electric vehicle. More particularly, it relates to a method configured for implementing a feeling of operation of a driving system of an internal combustion engine, a transmission, a clutch, etc and a feeling of driving of the internal combustion engine vehicle in an electric vehicle.

### Description of Related Art

As is known, an electric vehicle (EV) is a vehicle driven using an electric motor as a driving device for driving the vehicle. Among electric vehicles (electrified vehicles) in a broad sense each driven using an electric motor, a hybrid vehicle utilizes combined power of an internal combustion engine (ICE) and a motor, whereas each of a battery electric vehicle (BEV) and a fuel cell electric vehicle is an EV driven using only a motor.

A driving system of an EV driven using only a motor includes a battery that supplies power to drive the motor, an inverter connected to a battery, a motor as a driving device connected to the battery through an inverter so that charging and discharging are allowed, and a reducer that reduces rotation force of the motor and transmits the rotation force to a drive wheel.

Unlike a conventional ICE vehicle, in a general EV driven using only a motor in the present way, a multi-stage transmission is not used, and instead, a reducer using a fixed gear ratio is disposed between the motor and drive wheel.

A reason therefor is that, while an ICE (engine) has a wide distribution range of energy efficiency according to an operating point and may provide high torque only in a high-speed region, in the case of a motor, a difference in efficiency according to an operating point is relatively small, and low speed and high torque may be realized only by characteristics of a single motor.

Furthermore, the conventional ICE vehicle requires an oscillation mechanism such as a torque converter or clutch due to characteristics of the ICE that cannot be operated at low speed. However, in the driving system of the EV, the oscillation mechanism may be eliminated since the motor has characteristics of being operated at low speed. Due to such a mechanical difference, the EV may provide smooth drivability without interruption in drivability due to gear shifting, etc., unlike the ICE vehicle.

Furthermore, the driving system of the EV generates power by driving the motor using power of the battery rather than generating power by combusting fuel as in the ICE vehicle. Accordingly, unlike torque of the ICE vehicle generated by aerodynamic and thermodynamic reactions, torque of the EV is characterized by being generally more sophisticated, smoother, and more responsive than that of the ICE vehicle.

Furthermore, a main vibration source in a vehicle provided with a conventional ICE driving system is the ICE (engine). Vibrations generated by periodic explosive force of the ICE in an ignition-on state are transmitted to a vehicle body and passengers through the driving system, a mount, etc.

In general, these vibrations are considered negative factors that need to be damped. In this regard, the EV in which the motor replaces the ICE is advantageous over the ICE vehicle in terms of improving ride comfort because a vibration source is not present. Furthermore, the absence of a transmission in the EV is clearly advantageous in that smooth drivability is provided without interruption in drivability due to gear shifting.

However, a driver who desires a pleasure of driving may feel bored due to the lack of shift feeling, such as vibration or sound generated when gear shifting by the ICE or the transmission. It is sometimes necessary to provide not only a soft feeling but also a rough and trembling sensation in the EV having characteristics of aiming at high performance.

However, the EV has limitations in providing these emotional elements to the driver. Accordingly, there is a demand for a method configured for producing, in the EV, a virtual effect simulating shift feeling such as vibration or sound generated by an actual driving system during gear shifting in an ICE vehicle provided with an ICE and a multi-stage transmission.

It becomes necessary to provide a virtual drivability implementation function so that the driver may experience target sensation in the vehicle of the driver without changing to an ICE vehicle or another vehicle when the driver desires to feel driving sensation, fun, thrill, a direct connection feeling, etc. provided by an engine, a transmission, a clutch, etc.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method of controlling an EV allowing a driver to feel differentiated driving sensation and various driving pleasures by generating and producing a virtual shift feeling such as virtual vibration or sound generated by mechanical elements such as an ICE and a multi-stage transmission in the EV not provided with the ICE and the multi-stage transmission.

The object of the present disclosure is not limited to the object mentioned above, and other objects not mentioned herein may be clearly understood by those of ordinary skill in the art to which an exemplary embodiment of the present disclosure belongs (hereinafter referred to as “person of ordinary skill”) from the description below.

Various aspects of the present disclosure are directed to providing a method of implementing characteristics of an internal combustion engine (ICE) vehicle in an electric vehicle (EV), the method including determining, by a controller, a virtual gear shifting type based on vehicle driving information obtained during vehicle driving and starting virtual gear shifting, determining, by the controller, a magnitude of a virtual effect based on vehicle driving information obtained while the virtual gear shifting is performed, determining, by the controller, an amount of correction of the magnitude of the virtual effect based on the determined virtual gear shifting type and state information related to the virtual gear shifting while the virtual gear shifting is performed, correcting, by the controller, the determined magnitude of the virtual effect by the determined amount of correction of the magnitude of the virtual effect while the virtual gear shifting is performed, and generating and outputting, by the controller, a virtual effect signal including the corrected magnitude of the virtual effect, and controlling an operation of a virtual effect generation device according to the output virtual effect signal so that a virtual effect including the corrected magnitude is generated in a vehicle.

Other aspects and exemplary embodiments of the present disclosure are discussed infra.

The above and other features of the present disclosure are discussed infra.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating a configuration of a device configured for implementing characteristics of an ICE vehicle according to an exemplary embodiment of the present disclosure;

FIG. 2 is a flowchart illustrating a process of implementing characteristics of the ICE vehicle according to an exemplary embodiment of the present disclosure;

FIG. 3 is a diagram illustrating an exemplary embodiment of adjusting the volume of a virtual sound according to a virtual engine speed in an exemplary embodiment of the present disclosure;

FIG. 4 is a diagram illustrating an example of setting a gain value for adjusting the magnitude of a virtual effect in an exemplary embodiment of the present disclosure;

FIG. 5 is a diagram illustrating an exemplary embodiment in which the volume of the virtual sound is determined according to virtual gear shifting intervention torque in an exemplary embodiment of the present disclosure;

FIG. 6 is a diagram illustrating a method of determining the sound volume based on a time-axis map in an exemplary embodiment of the present disclosure;

FIG. 7A is a diagram illustrating an example in which a virtual gear shifting progress rate is determined in an exemplary embodiment of the present disclosure; and

FIG. 7B is a diagram illustrating an exemplary embodiment in which the volume of the virtual sound is determined according to the virtual gear shifting progress rate in an exemplary embodiment of the present disclosure.

It should be understood that the appended drawings are not necessarily to scale, presenting a somewhat simplified representation of various exemplary features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, the present disclosure will be described in detail with reference to the accompanying drawings. Specific structural or functional descriptions presented in the exemplary embodiments of the present disclosure are only illustrative for describing embodiments according to the concept of the present disclosure, and the exemplary embodiments according to the concept of the present disclosure may be implemented in various forms. Furthermore, the present disclosure should not be construed as being limited to the exemplary embodiments described herein, and should be understood to include all modifications, equivalents, and substitutes included in the spirit and scope of the present disclosure.

Meanwhile, in an exemplary embodiment of the present disclosure, even though terms such as “first,” “second,” etc. may be used to describe various elements, the elements are not limited by these terms. These terms are only used to distinguish one element from another. For example, within the scope not departing from the scope of rights according to the concept of the present disclosure, a first element may be referred to as a second element, and similarly, the second element may be referred to as the first element.

When an element is referred to as being “coupled” or “connected” to another element, the element may be directly coupled or connected to the other element. However, it should be understood that another element may be present therebetween. In contrast, when an element is referred to as being “directly coupled” or “directly connected” to another element, it should be understood that there are no other elements therebetween. Other expressions for describing a relationship between elements, that is, expressions such as “between” and “immediately between” or “adjacent to” and “directly adjacent to,” should be interpreted similarly.

Like reference numerals refer to like elements throughout the entire specification. The terminology used herein is for describing the embodiments, and is not intended to limit the present disclosure. In the present specification, a singular expression includes the plural form unless the context clearly dictates otherwise. Referring to expressions “comprises” and/or “comprising” used in the specification, a mentioned component, step, operation, and/or element does not exclude the presence or addition of one or more other components, steps, operations, and/or elements.

Various aspects of the present disclosure are directed to providing a method configured for generating and producing a virtual shift feeling such as virtual vibration or sound felt during actual gear shifting by mechanical elements such as in an ICE and a multi-stage transmission in an EV not provided with the ICE and the multi-stage transmission.

The EV to which an exemplary embodiment of the present disclosure is applied may be an EV driven only by a motor. For example, the EV to which an exemplary embodiment of the present disclosure is applied may be a BEV or a fuel cell vehicle.

In an exemplary embodiment of the present disclosure, the virtual shift feeling includes one or both of virtual vibration and virtual sound during virtual gear shifting that simulate vibration and sound generated during actual gear shifting of the ICE vehicle.

The virtual vibration or sound simulates vibration or sound generated by mechanical elements of the ICE vehicle, such as the ICE and the multi-stage transmission, which are absent in the EV. In the following description, virtual vibration and virtual sound simulating and implementing characteristics of an actual ICE vehicle will be collectively referred to as “virtual effect.”

Furthermore, in an exemplary embodiment of the present disclosure, a function of generating and producing virtual vibration or sound to simulate and implement characteristics of the actual ICE vehicle will be referred to as “virtual effect implementation function.”

Furthermore, in the following description, in the virtual effect implementation function, a virtual gear shifting function refers to a function of generating a virtual shift feeling simulating an actual shift feeling such as vibration or sound generated during actual gear shifting of the ICE vehicle as described above.

Furthermore, in an exemplary embodiment of the present disclosure, a virtual effect during virtual gear shifting may have the same meaning as the virtual shift feeling, and includes one or both of virtual vibration and virtual sound simulating vibration and sound during actual gear shifting in the actual shift feeling generated by the ICE and the multi-stage transmission.

In performing the virtual effect implementation function, highly realistic sensation may be provided to the driver when a virtual effect linked to characteristics of the driving system is generated. However, conventional technology has limitations in implementing a strategy for linking with the characteristics of the driving system, and has been at a level of simply generating an effect linked with only an accelerator pedal input value (APS value), a driving system speed, or a vehicle speed, which is one of driving input values of the driver.

Furthermore, there is a limit to implementing a realistic virtual effect only by a virtual engine speed obtained from motor torque corresponding to an accelerator pedal input value or a driving system speed and displayed through a cluster.

Therefore, it is necessary to be able to determine the amplitude of virtual vibration or the volume of virtual sound, which can simulate physical vibration, sound, shift feeling, etc. generated by the actual ICE (engine) and the transmission more closely to the real one.

Generating a virtual effect simply linked only to the accelerator pedal input value (APS value), a driving system speed, or the speed, as in the related art, has limitations in providing realistic driving sensation, and thus the present disclosure presents a specific method for generating a more realistic virtual effect. Accordingly, the object of the present disclosure may be defined as follows.

Various aspects of the present disclosure are directed to providing a method of determining the amplitude of vibration or the volume of sound produced during virtual gear shifting to provide a highly realistic virtual effect in relation to the virtual effect implementation function performed in the EV.

To the present end, to generate a dynamic emotional effect without a sense of difference, a method of implementing characteristics of the ICE vehicle and implementing a virtual effect according to an exemplary embodiment of the present disclosure may include one of a method of determining the magnitude of the virtual effect according to the virtual engine speed, a method of determining the magnitude of the virtual effect according to virtual gear shifting intervention torque, a method of determining the magnitude of the virtual effect based on a time-axis map, and a method of determining the magnitude of the virtual effect based on a virtual gear shifting progress rate map.

An actual shift feeling including vibration, sound, etc. during gear shifting in an existing vehicle provided with the ICE and the transmission is generated according to physical load actually generated by the ICE and changes in actual speeds (driving system speed as rotation speed) of driving system elements generated by operation of the transmission.

However, in the case of the EV performing the virtual effect implementation function, the mechanical elements are not physically present. Thus, even though a virtual effect may be implemented, produced, and provided to the driver only by generating a virtual signal, when amplitude and sound volume of a virtual effect signal are set depending only on motor torque or reducer speed information, an accelerator pedal input value (APS value), etc. of the EV, a difference from nature of a target to be implemented inevitably occurs.

Therefore, the present disclosure is directed to providing a method of inversely determining a physical state variable that should have been generated in the existing ICE (engine) and transmission system, setting the magnitude of a more realistic virtual effect based thereon.

Here, the magnitude of the virtual effect includes at least one of the amplitude of the virtual vibration or the volume of the virtual sound. Furthermore, the physical state variable may include engine intervention torque, driving system equivalent inertia, a gear shifting type, a gear shifting progress rate, etc. during gear shifting.

Because an actual engine (ICE) and transmission are not present in the EV, the present disclosure may virtually determine the physical state variables and determine the magnitude of the virtual effect (amplitude of vibration and volume of sound) to be implemented and provided in the EV based on the determined virtual state variables. Furthermore, based on the same principle, it is possible to generate and provide realistic virtual vibration and sound effects in a vehicle provided with the existing ICE and transmission.

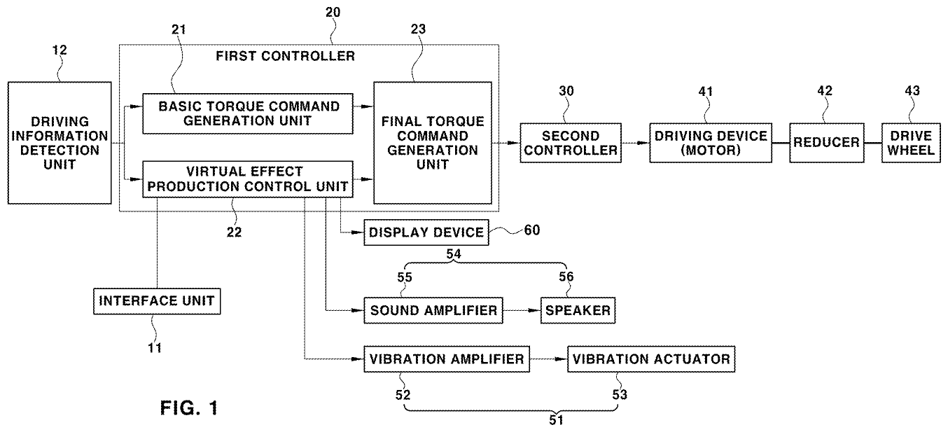

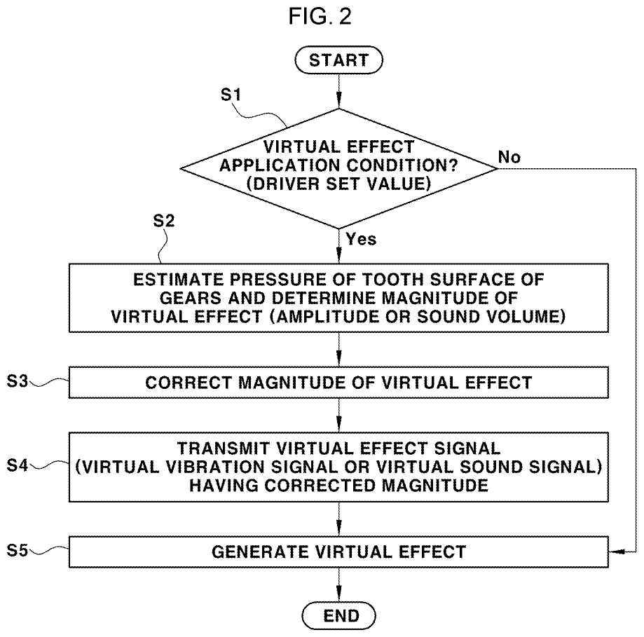

FIG. 1 is a block diagram illustrating a configuration of a device configured for implementing characteristics of an ICE vehicle according to an exemplary embodiment of the present disclosure, and FIG. 2 is a flowchart including S1, S2, S3, S4 and S5 illustrating a process of implementing characteristics of the ICE vehicle according to an exemplary embodiment of the present disclosure.

In an exemplary embodiment of the present disclosure, implementing characteristics of the ICE vehicle means generating and providing a virtual effect in the EV. That is, implementing characteristics of the ICE vehicle means actually generating vibration and sound similar to those generated in the ICE vehicle in the EV even though the vibration and sound are not actually generated during operation of the driving system in the EV, which is a target vehicle.

Implementing the characteristics of the ICE vehicle in an exemplary embodiment of the present disclosure means actually generating, producing, and providing, by the EV, vibration and sound simulating those generated by the driving system of the ICE vehicle as closely as possible according to characteristics of the driving system, an operation condition of the driving system, a vehicle driving state, etc.

In an exemplary embodiment of the present disclosure, vibration simulating actual vibration in the ICE vehicle is defined as “virtual vibration,” and sound simulating actual sound in the ICE vehicle is defined as “virtual sound.” In the following description, “virtual effect” includes one or both of virtual vibration and virtual sound as described above.

In an exemplary embodiment of the present disclosure, in the virtual effect, the virtual vibration is generated using a vibration device or a driving motor so that the driver may feel the virtual vibration during virtual gear shifting simulating actual gear shifting, and the virtual sound is generated using a sound device provided in the vehicle so that the driver may hear the virtual sound during virtual gear shifting.

As illustrated in FIG. 1, the device configured for implementing the characteristics of the ICE vehicle according to an exemplary embodiment of the present disclosure is provided in the vehicle, and includes a driving information detection unit 12 which is configured to detect vehicle driving information, a first controller 20 that generates and outputs a torque command based on the vehicle driving information detected by the driving information detection unit 12, and a second controller 30 that is configured to control an operation of a driving device 41 according to the torque command output from the first controller 20.

In the following description, a control subject is divided into the first controller 20 and the second controller 30. However, a control process for implementing characteristics of the ICE vehicle and implementing the virtual effect according to an exemplary embodiment of the present disclosure may be performed by one integrated control element instead of a plurality of controllers.

The plurality of controllers and the one integrated control element may be collectively referred to as a controller, and the control process of the present disclosure may be performed by the collectively named controller. In the following description, the “controller” may collectively refer to the first controller 20 and the second controller 30.

The driving information detection unit 12 is a component which is configured to detect vehicle driving information required to determine required torque of the driver and perform the virtual effect implementation function in the vehicle. Here, the vehicle driving information is information indicating a vehicle driving state, and may include driving input information of the driver and vehicle state information.

In various exemplary embodiments of the present disclosure, the driving information detection unit 12 may include an accelerator pedal detection unit which is configured to detect an accelerator pedal input value according to an accelerator pedal operation of the driver, a brake pedal detection unit which is configured to detect a brake pedal input value according to a brake pedal operation of the driver, and a vehicle speed detection unit which is configured to detect a vehicle speed.

Here, the accelerator pedal detection unit may be a conventional accelerator pedal sensor (APS) provided on the accelerator pedal to output an electrical signal according to an accelerator pedal operation state of the driver. The brake pedal detection unit may be a conventional brake pedal sensor (BPS) provided on the brake pedal to output an electrical signal according to a brake pedal operation state of the driver.

The vehicle speed detection unit may include a wheel speed sensor, and because obtaining vehicle speed information from a wheel speed signal output by the wheel speed sensor is a well-known technique in the art, a detailed description thereof will be omitted.

Accordingly, in the vehicle driving information detected by the driving information detection unit 12, the driving input information of the driver may be a pedal input value of the driver, and includes an accelerator pedal input value (APS value) detected by the accelerator pedal detection unit as a driving input value according to the accelerator pedal operation of the driver, and a brake pedal input value (BPS value) detected by the brake pedal detection unit as a driving input value according to the brake pedal operation of the driver. At the instant time, the vehicle speed detected by the vehicle speed detection unit becomes the vehicle state information in the vehicle driving information.

Furthermore, the driving information detection unit 12 may further include a speed detection unit which is configured to detect a rotation speed of the vehicle driving system. Here, the rotation speed (driving system speed) of the vehicle driving system may include a rotation speed (motor speed) of the motor, which is the driving device 41, and a rotation speed (drive wheel speed) of a drive wheel 43. Furthermore, the rotation speed (driving system speed) of the vehicle driving system may further include a rotation speed (driveshaft speed) of a driveshaft.

At the present time, the speed detection unit includes a motor speed detection unit provided in the motor, which is the driving device 41, and a wheel speed detection unit provided in the drive wheel 43. Furthermore, the motor speed detection unit may be a normal resolver, and the wheel speed detection unit may be a normal wheel speed sensor.

Furthermore, the speed detection unit may further include a sensor configured for detecting the driveshaft speed. Furthermore, at the instant time, the vehicle driving information further includes the rotation speed (drive wheel speed) of the vehicle driving system, and the rotation speed of the vehicle driving system becomes vehicle state information in the vehicle driving information.

Meanwhile, among the components of the device illustrated in FIG. 1, the first controller 20 is configured to determine, generate, and output a torque command for controlling the operation of the driving device 41 based on real-time vehicle driving information. Here, the driving device 41 is a motor that drives the vehicle.

The first controller 20 includes a basic torque command generation unit 21 that is configured to determine required torque of the driver from the real-time vehicle driving information obtained through the driving information detection unit 12 and generates a basic torque command for generating the determined required torque of the driver.

Furthermore, the first controller 20 further includes a virtual effect production control unit 22 that generates a virtual effect command for generating and producing a virtual effect based on real-time driving system state information.

Furthermore, the first controller 20 further includes a final torque command generation unit 23 that generates and outputs a final torque command using a basic torque command generated and output by the basic torque command generation unit 21 and a virtual effect command (virtual effect signal) generated and output by the virtual effect production control unit 22.

In the case of a vehicle provided with a separate vibration device, the virtual effect command includes one or both of a vibration effect command (vibration effect signal) for controlling an operation of a vibration device 51 for generating virtual vibration, and a sound effect command (sound effect signal) for controlling an operation of a sound device 54 for generating virtual sound.

In a vehicle without the vibration device 51, virtual vibration may be generated and produced through a motor, which is the driving device 41, while the vehicle is driven, and at the instant time, the vibration effect command during virtual gear shifting becomes virtual gear shifting intervention torque for the motor, which is the driving device 41, instead of being used to control the operation of the vibration device 51.

In the present way, the virtual gear shifting intervention torque is command torque (vibration effect command) for generating and producing a virtual effect during performance of virtual gear shifting, and is used as correction torque for correcting the basic torque command during virtual gear shifting in the final torque command generation unit 23 of the first controller 20.

In an exemplary embodiment of the present disclosure, the basic torque command during virtual gear shifting is corrected to a motor torque command (final torque command) for generating virtual vibration by the virtual gear shifting intervention torque. That is, the final torque command generation unit 23 of the first controller 20 utilizes the basic torque command generated and input by the basic torque command generation unit 21 and the virtual gear shifting intervention torque generated and input by the virtual effect production control unit 22 to generate a motor torque command for generating virtual vibration as a final torque command during virtual gear shifting.

In various exemplary embodiments of the present disclosure, the virtual effect production control unit 22 of the first controller 20 may be set to determine a tooth surface pressure of driving system gears based on the real-time driving system state information, and to generate a virtual effect command for generating and producing a virtual effect by use of the determined tooth surface pressure of the driving system gears.

In the EV, a degree to which vibration is radiated to a vehicle body and cabin through the driving system of the vehicle is proportional to the tooth surface pressure of the driving system gears. Here, the driving system gears include gears that transmit torque between the motor, which is the driving device 41, and the drive wheel 43, and these gears may refer to gears in a known driving system in which rotation force is transmitted between the motor and the drive wheel in the EV. In the EV, representative driving system gears include gears of a reducer 42.

In the EV and the ICE vehicle, the driving system gears transmit torque (and force) through mutual meshing and simultaneous rotation. In the driving system of the ICE vehicle, as the tooth surface pressure of the gears increases, vibration transmission characteristics between various moving parts of the driving system become closer to those of a rigid body, and thus a transmission rate of vibration generated in the ICE increases.

Conversely, as the tooth surface pressure of the driving system gears decreases, stress between adjacent moving parts decreases, and thus vibration is hardly transmitted. Therefore, vibration energy is attenuated by a surrounding lubricating part, and thus a vibration transmission rate is lowered. That is, as the magnitude (absolute value of the pressure) of the tooth surface pressure of the driving system gears increases, the magnitude of vibration increases, and as the magnitude of the tooth surface pressure of the driving system gears decreases, the magnitude of vibration decreases.

Considering the present fact, in an exemplary embodiment of the present disclosure, the magnitude of the virtual effect (amplitude of vibration and volume of sound) may be increased as the magnitude of the tooth surface pressure (absolute value of the pressure) of the driving system gears increases, and the magnitude of the virtual effect may be decreased as the magnitude of the tooth surface pressure of the driving system gears decreases.

In an exemplary embodiment of the present disclosure, the tooth surface pressure of the driving system gears may be determined using a shaft torsion speed, a backlash speed, and input torque in the driving system, which are driving system state information. Here, the input torque refers to torque applied from the motor to the driving system, and a motor torque command, that is, a basic torque command determined by the basic torque command generation unit 21 of the first controller 20 may be used as the input torque.

Furthermore, the shaft torsion speed and backlash speed may be determined from the real-time vehicle driving information, and may be determined using the motor speed and wheel speed (drive wheel speed) together with the motor torque command.

The shaft torsion speed may be determined from input torque applied to the driving system from the motor and driving system spring stiffness, where the input torque may be a motor torque command (basic torque command). In the present instance, the shaft torsion speed may be determined as a value obtained by multiplying the motor torque command, which is the input torque, by the driving system spring stiffness. The driving system spring stiffness may be determined through a determination process using a formula based on a driving system rotation speed difference generated between the motor and the drive wheel and the input torque.

The driving system rotation speed difference may be determined as a difference between the motor speed detected by the motor speed detection unit and an equivalent wheel speed, and the equivalent wheel speed is an equivalent wheel speed in the motor determined by use of a gear ratio between the motor and the drive wheel from the wheel speed (drive wheel speed) detected by the wheel speed detection unit.

The backlash speed is due to the driving system rotation speed difference generated between the motor and the drive wheel, and may be determined as a value obtained by filtering a difference between the driving system rotation speed difference and the shaft torsion speed.

Meanwhile, the final torque command generated by the final torque command generation unit 23 is transmitted to the second controller 30, and the second controller 30 is configured to control operation of the driving device 41 that drives the vehicle according to the final torque command. Here, the driving device 41 is a motor that drives the vehicle.

As illustrated in FIG. 1, the rotation force and the torque output by the motor, which is the driving device 41, are reduced by the reducer 42 and then transmitted to the drive wheel 43. When the operation of the motor is controlled by the second controller 30 according to the final torque command of the first controller 20, it is possible to implement virtual ICE driving system characteristics and a virtual effect by the motor.

At the present time, the final torque command generated and output by the first controller 20 is a motor torque command configured for realizing the virtual ICE driving system characteristics while driving the vehicle, and when the operation of the motor, which is the driving device 41 of the vehicle, is controlled according to the final torque command, it is possible to output motor torque which may cause virtual vehicle vibration and behavior simulating a vehicle vibration and behavior state in the actual ICE vehicle.

Furthermore, during virtual gear shifting simulating a vibration and behavior state during actual gear shifting of the ICE vehicle, a final torque command may be generated using a basic torque command and virtual transmission intervention torque. When the operation of the motor is controlled by the present final torque command, a vehicle vibration and behavior state may be implemented and produced during virtual gear shifting by the motor, which will be described in more detail later.

In an exemplary embodiment of the present disclosure, the first controller 20 may be a vehicle control unit (VCU) that generates a motor torque command based on vehicle driving information in a typical EV, and the second controller 30 may be a motor control unit (MCU) that is configured to control the operation of the motor according to the motor torque command.

In an exemplary embodiment of the present disclosure, the virtual effect production control unit 22 is a novel component for generating and outputting, as a command, a virtual effect signal for generating and producing virtual vibration and virtual sound separately from the basic torque command generation unit 21 and the basic torque command generated by the basic torque command generation unit 21, and may be added as a part of the VCU in the VCU or provided as a control element separate from the VCU.

Here, the virtual effect signal (virtual vibration signal and virtual sound signal) may be a waveform signal having the magnitude (amplitude and sound volume) of a virtual effect corresponding to a driving system state, for example, the tooth surface pressure of the driving system gears. In the present instance, the virtual effect production control unit 22 may be configured to generate and output a command (a virtual effect command, that is, a virtual vibration command and a virtual sound command) including a value of the waveform signal as the virtual effect signal.

In an exemplary embodiment of the present disclosure, for the virtual effect signal including the magnitude (amplitude and sound volume) corresponding to the driving system state (for example, the tooth surface pressure of the driving system gears), during virtual gear shifting, the virtual effect production control unit 22 corrects the magnitude (amplitude and sound volume) of the virtual effect using information collected during virtual gear shifting as described below, and then transmits the virtual effect signal including the corrected magnitude to the final torque command generation unit 23.

In the final torque command generation unit 23, the basic torque command input from the basic torque command generation unit 21 is corrected by the virtual effect command (command including corrected magnitude) input from the virtual effect production control unit 22. At the instant time, correction may be performed by adding the virtual effect command to the basic torque command. As a result, the torque command corrected by the virtual effect command becomes the final torque command for motor control.

In an exemplary embodiment of the present disclosure, the virtual effect command determined by the virtual effect production control unit 22 during virtual gear shifting and transmitted to the final torque command generation unit 23 is virtual gear shifting intervention torque, which will be described in detail later.

As a result, virtual vibration linked to the driving system state may be generated by the motor driving the vehicle, which is vibration simulating vibration which may be generated in the existing ICE vehicle and is vibration actually generated in the vehicle by the motor when the operation of the motor is controlled according to the final torque command. As described above, the motor is a driving device configured for driving the vehicle, and functions as a virtual effect generation device configured for generating a virtual effect.

Furthermore, the device configured for implementing the characteristics of the ICE vehicle according to an exemplary embodiment of the present disclosure may further include an interface unit 11 used by the driver to select and input one of an ON state and an OFF state of the virtual effect implementation function.

In an exemplary embodiment of the present disclosure, any means allowing the driver to selectively operate the ON state and the OFF state in the vehicle and configured for outputting an electrical signal according to the ON state and the OFF state may be used as the interface unit 11. For example, it is possible to use an operating device such as a button or switch provided in the vehicle, an input device of an Audio, Video and Navigation (AVN) system, or a touchscreen.

The interface unit 11 may be connected to the first controller 20, and to the virtual effect production control unit 22 in the first controller 20. Accordingly, when there is an on or off operation by the driver through the interface unit 11, an on signal or off signal may be input by the interface unit 11 to the virtual effect production control unit 22 of the first controller 20. As a result, the virtual effect production control unit 22 of the first controller 20 may recognize an on or off operating state of the virtual effect implementation function by the driver.

In an exemplary embodiment of the present disclosure, the virtual effect implementation function may be executed only when the driver inputs the ON state of the virtual effect implementation function through the interface unit 11. Furthermore, when the interface unit 11 is an input device provided in the vehicle, a mobile device may be used as the interface unit 11 instead of such an input device of the vehicle although not illustrated in FIG. 1, and the driver may turn on or off the virtual effect implementation function through the mobile device.

The mobile device needs to be communicatively connectable to an in-vehicle device, for example, the first controller 20. To the present end, an input/output communication interface for communication connection between the mobile device and the first controller 20 is used.

Furthermore, the driver may set a virtual effect application condition such as a set value using the interface unit 11, and when the virtual effect application condition is satisfied, the virtual effect implementation function according to an exemplary embodiment of the present disclosure may be executed (see step S1 of FIG. 2).

Furthermore, the device configured for implementing the characteristics of the ICE vehicle according to an exemplary embodiment of the present disclosure may further include one or both of the vibration device 51 that generates virtual vibration and the sound device 54 that generates and outputs virtual sound.

The vibration device 51 and the sound device 54 are virtual effect generation devices for generating a virtual effect together with the motor, which is the driving device 41. In an exemplary embodiment of the present disclosure, one of the motor and the vibration device 51 may be used to generate virtual vibration.

As described above, virtual vibration may be generated using the motor driving the vehicle in an exemplary embodiment of the present disclosure. However, virtual vibration may be generated using the separate vibration device 51 provided in the vehicle instead of the motor.

The vibration device 51 is configured to generate vibration according to a virtual effect signal (virtual effect command) for generating and producing an electrical signal output from the virtual effect production control unit 22 of the first controller 20, that is, a virtual effect.

The vibration device 51 may include a vibration amplifier 52 that receives a virtual effect signal and outputs an amplified vibration signal, and a vibration actuator 53 that generates vibration by the amplified vibration signal output from the vibration amplifier 52.

A known amplifier and actuator for generating vibration may be used as the vibration amplifier 52 and the vibration actuator 53. Furthermore, the vibration actuator 53 of the vibration device 51 may be provided at a predetermined location of the vehicle where the driver may feel vibration generated therefrom.

For example, the vibration actuator 53 of the vibration device 51 may be provided in a vehicle body or seat, and may be provided at a location where vibration generated while driving may be transmitted to the driver through the vehicle body or seat.

The sound device 54 is provided to generate sound according to an electrical signal output from the virtual effect production control unit 22 of the first controller 20, that is, a virtual effect signal for generating and producing a virtual effect.

The sound device 54 may include a sound amplifier 55 that receives a virtual effect signal and outputs an amplified sound signal, and a speaker 56 that outputs sound by the amplified sound signal output from the sound amplifier 55.

A known amplifier and speaker for generating and outputting sound may be used as the sound amplifier 55 and the speaker 56, and those previously provided in the vehicle may be used. The speaker 56 may be a speaker mounted inside or outside the vehicle to output sound.

Furthermore, the device configured for implementing the characteristics of the ICE vehicle according to an exemplary embodiment of the present disclosure may further include a display device 60 that displays information related to implementation of a virtual effect and provides the information to the driver. The display device 60 may be a display device disposed in front of a driver seat, which may be previously provided in the vehicle.

In detail, the display device 60 may be a cluster disposed in front of the driver seat. The information related to implementation of the virtual effect displayed through the display device 60 may include a virtual engine speed and a virtual current shifting stage.

In an exemplary embodiment of the present disclosure, it has been described that the vehicle driving information is used to produce and implement a virtual effect, and virtual variable information obtained from the vehicle driving information, which is actual driving variable information, may be used to generate a virtual effect signal (virtual effect command). Itis possible to use a virtual engine speed, which is virtual variable information obtained from an actual driving system speed detected by a sensor in the vehicle.

The virtual engine speed is a virtual speed determined by the virtual effect production control unit 22 of the controller, that is, the first controller 20, from the driving system speed, which is the actual driving variable information. In various exemplary embodiments of the present disclosure, a preset ICE model may be used to obtain a virtual engine speed from an actual driving variable in the EV.

In various exemplary embodiments of the present disclosure, when a virtual ICE model including a virtual engine and a virtual transmission is used, the virtual engine speed becomes an input speed of the virtual transmission. In the present instance, the virtual engine speed and the input speed of the virtual transmission may be determined as values linked with an actual motor speed. That is, the virtual engine speed may be determined as a variable multiple of the driving system speed detected by the speed detection unit, where the driving system speed may be a motor speed.

In the present way, the virtual engine speed may be determined as a multiple of the motor speed by multiplying the motor speed by a coefficient. In the present instance, a value of the variable coefficient multiplied by the motor speed to determine the virtual engine speed may be a value determined according to a virtual transmission and gear ratio model and a virtual current shifting stage. Furthermore, an added engine speed determined in the instant way may be displayed through the display device 60.

Furthermore, it is possible to apply a control method for generating a virtual shift feeling of the EV together with the present disclosure to the EV without the multi-stage transmission so that a multi-stage shift feeling may be generated and implemented through torque control of the motor, which is the driving device 41. A virtual engine speed may be used as virtual variable information required to generate and implement the multi-stage shift feeling in a control process for generating the virtual shift feeling of the EV.

Furthermore, the virtual effect production control unit 22 may be configured to determine the virtual engine speed using a virtual vehicle speed and gear ratio information of the virtual current shifting stage. Here, the virtual vehicle speed may be determined as a value directly proportional to the actual motor speed using the actual motor speed, which is actual driving variable information, and a final reduction gear ratio. The virtual final reduction gear ratio is a value previously set in the virtual effect production control unit 22.

Accordingly, the virtual vehicle speed may be determined using the virtual final reduction gear ratio and the actual motor speed measured during vehicle driving, and the virtual engine speed may be determined in real time by the virtual vehicle speed. In the present instance, the virtual engine speed may be obtained from a value obtained by multiplying the virtual vehicle speed by a virtual gear ratio of the virtual current shifting stage, or the virtual engine speed may be obtained from a value obtained by multiplying the driving system speed, such as the motor speed, by the virtual gear ratio of the virtual current shifting stage.

Furthermore, the virtual current shifting stage may be determined according to a shift schedule map preset in the virtual effect production control unit 22 from the virtual vehicle speed and the accelerator pedal input value (APS value). Furthermore, the virtual current shifting stage determined in the instant way may be displayed through the cluster which is the display device 60. When the virtual current shifting stage is determined as described above, the virtual engine speed may be determined in real time using the virtual gear ratio corresponding to the shifting stage and the virtual vehicle speed or motor speed.

Furthermore, while the EV is driven, the basic torque command generation unit 21 is configured to determine the basic torque command in real time based on the vehicle driving information collected from the vehicle, and separately from this, the virtual effect production control unit 22 verifies whether a virtual gear shifting stage obtained by a shift schedule map from a current virtual vehicle speed the accelerator pedal input value is different from a previous virtual gear shifting stage.

When the virtual gear shifting stage changes, it is determined that a shift event starts. That is, it is verified whether the virtual gear shifting stage obtained by the shift schedule map is changed, and the change of the virtual gear shifting stage means that a new virtual gear shifting stage different from a current virtual gear shifting stage is determined.

Upon determining that the shift event has started, the virtual effect production control unit 22 is configured to determine a virtual gear shifting stage newly obtained based on the shift schedule map as a virtual target shifting stage, and is configured to determine gear shifting classes from the virtual current shifting stage (previous shifting stage) and the virtual target shifting stage.

The gear shifting classes may be classified as power-on upshift, power-off upshift (lift-foot-up), power-on downshift (kick-down), power-off downshift, near-stop downshift, etc., and one of the gear shifting classes may be selected and determined from the virtual current shifting stage and the virtual target shifting stage.

In various exemplary embodiments of the present disclosure, to determine the virtual gear shifting intervention torque as a torque value of a virtual effect command during virtual gear shifting, the virtual effect production control unit 22 is configured to determine a current virtual gear shifting class (virtual gear shifting type).

For example, the case where the virtual target shifting stage is higher than the virtual current shifting stage (that is, virtual target shifting stage >virtual current shifting stage) is upshift. Conversely, the case where the virtual target shifting stage is lower than the virtual current shifting stage (that is, virtual target shifting stage <virtual current shifting stage) is downshift. Furthermore, the case where the basic torque command is greater than a predetermined reference torque value is power-on, and the converse case is power-off.

As a result, in an exemplary embodiment of the present disclosure, when a current gear shifting class (virtual gear shifting type) is determined based on the virtual current shifting stage and the virtual target shifting stage, a virtual gear shifting intervention torque profile corresponding to the current gear shifting class is selected among virtual gear shifting intervention torque profiles for each gear shifting class, and virtual gear shifting intervention torque for generating a virtual shift feeling may be determined in real time according to the selected virtual gear shifting intervention torque profile. At the instant time, a virtual gear shifting intervention torque value corresponding to a current virtual gear shifting progress rate may be determined from the selected virtual gear shifting intervention torque profile.

The virtual gear shifting intervention torque profile is information set for each gear shifting class in a virtual transmission model of the virtual effect production control unit 22, and in the virtual gear shifting intervention torque profile, the magnitude of the virtual gear shifting intervention torque may be adjusted using, as a variable for setting the torque magnitude, a combination of the virtual engine speed, the accelerator pedal input value (APS value), the motor torque (the basic torque command generated by the basic torque command generation unit), and one or both of the virtual current shifting stage and the virtual target shifting stage.

Furthermore, the virtual effect production control unit 22 may set a time point at which the virtual gear shifting stage is changed (that is, a time point at which a new virtual target shifting stage is determined) to 0, start to count time from the time point, and then determine, as a virtual gear shifting progress rate (%), a percentage of the counted time to a preset total shift time over time. Since actual gear shifting is not performed in the EV, the shift progress rate (%) is a virtual progress rate.

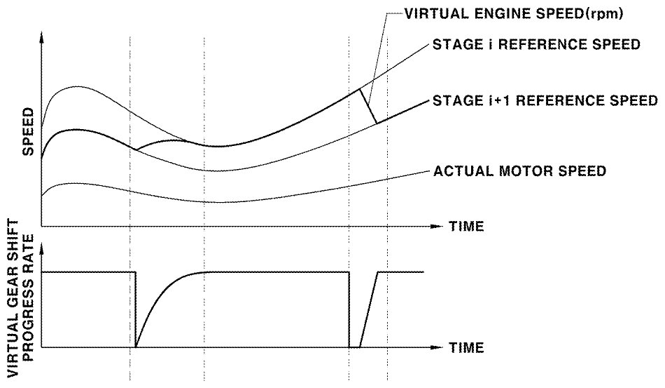

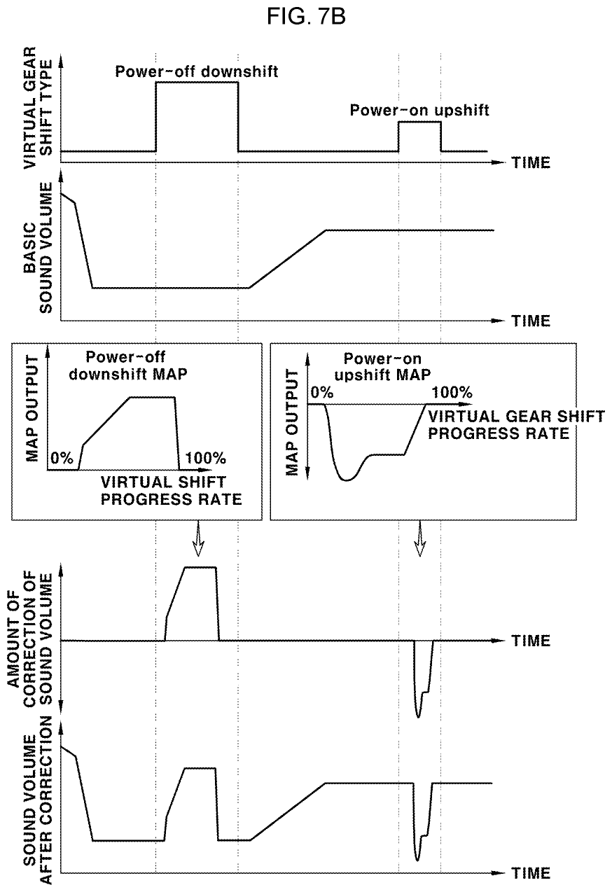

Alternatively, after determining a total estimated required time (Time Tot) until completion of virtual gear shifting, and determining a remaining estimated required time until completion of virtual gear shifting during virtual operation in real time, it is possible to determine a virtual gear shifting progress rate until completion of virtual gear shifting in real time using the total estimated required time and the remaining estimated required time. A method of determining such a virtual gear shifting progress rate will be described in more detail later with reference to FIG. 7A.

The virtual gear shifting progress rate (%) increases up to 100% over time. In the present way, when the virtual gear shifting progress rate is determined in real time, the virtual effect production control unit 22 is configured to determine a virtual gear shifting intervention torque value corresponding to the determined virtual gear shifting progress rate by use of the virtual gear shifting intervention torque profile.

As a result, when the virtual gear shifting intervention torque (intervention torque for producing a virtual effect) is determined in real time, as described above, the final torque command generation unit 23 corrects the basic torque command determined by the basic torque command generation unit 21 by the virtual gear shifting intervention torque determined by the virtual effect production control unit 22 to determine and generate the final torque command in real time, so that the torque output of the motor may be controlled according to the final motor torque command thereafter.

By controlling the torque output of the motor, the motor outputs torque in which the virtual gear shifting intervention torque is reflected in real time, and a virtual shift feeling may be implemented and provided by the motor torque output at the instant time.

Meanwhile, a method of implementing the characteristics of the ICE vehicle according to an exemplary embodiment of the present disclosure includes a process of determining a virtual gear shifting type and starting virtual gear shifting, a process of determining the basic magnitude of the virtual effect in real time based on vehicle driving information obtained while virtual gear shifting is performed, a process of determining the amount of correction of the magnitude of the virtual effect in real time based on the determined virtual gear shifting type and state information related to virtual gear shifting collected while virtual gear shifting is performed, and a process of correcting the basic magnitude of the virtual effect by the amount of correction of the magnitude of the virtual effect at a same time.

Furthermore, the method of implementing the characteristics of the ICE vehicle may further include a process of generating and outputting a virtual effect signal having the corrected magnitude of the virtual effect to control an operation of a virtual effect generation device according to the output virtual effect signal so that a virtual effect having the corrected magnitude is generated in the vehicle

Here, the state information related to virtual gear shifting may be one of a virtual engine speed, virtual gear shifting intervention torque, an elapsed time from the start of virtual gear shifting, and the virtual gear shifting progress rate map.

Accordingly, in the method of implementing the characteristics of the ICE vehicle according to an exemplary embodiment of the present disclosure, to determine and correct the magnitude of the virtual effect, it is possible to use one of a method of determining the magnitude of the virtual effect according to the virtual engine speed, a method of determining the magnitude of the virtual effect according to the virtual gear shifting intervention torque, a method of determining the magnitude of the virtual effect using the time-axis map, and a method of determining the magnitude of the virtual effect using the virtual gear shifting progress rate map.

In each method of determining the magnitude of the virtual effect, after determining the amount of correction of the magnitude of the virtual effect, the magnitude of the virtual effect is corrected in real time using the determined amount of correction of the magnitude of the virtual effect. Here, the amount of correction of the magnitude of the virtual effect may include at least one of the amount of correction of the amplitude for correcting the amplitude of the virtual vibration or the amount of correction of the sound volume for correcting the volume of the virtual sound.

Hereinafter, the method of implementing the characteristics of the ICE vehicle will be described in more detail. In the following description, the sound volume refers to the volume of the virtual sound, and the sound volume corresponds to the magnitude of the virtual effect. In the following description, the sound volume may be replaced with the magnitude of the virtual effect or the amplitude of the virtual vibration.

First, a description will be provided of an exemplary embodiment of adjusting the magnitude of the virtual effect, for example, the volume of the virtual sound (or the amplitude of the virtual vibration) according to the virtual engine speed.

As a method of adjusting the volume of the virtual sound, it is possible to correct the volume of the virtual sound by the amount of correction of the sound volume (the amount of increase or decrease of the sound volume) determined according to the virtual engine speed. At the instant time, it is possible to apply a method of determining the amount of correction of the sound volume, which is the amount of correction of the magnitude of the virtual effect, based on the virtual gear shifting type and the change rate of the virtual engine speed, and correcting basic sound volume of existing virtual sound determined from vehicle driving information by the determined amount of correction of the sound volume.

When shifting is performed in an existing vehicle provided with an ICE and a transmission, an actual engine speed fluctuates. Vibration or sound (noise) felt by the driver during shifting is affected by physical characteristics generated at the instant time.

In general, in performing control for inducing an increase or decrease in engine speed during shifting, control involving generation of additional torque or disconnection of torque of the engine is performed. A reason for performing the present control is to offset the inertial energy generated due to the increase and decrease of the speed of the driving system in a shifting section, which is proportional to the equivalent inertia of the driving system, the speed of which increases or decreases.

For example, when the driving system speed increases, the driving system needs to absorb energy, the amount of which is proportional to equivalent inertia of a driving system element that accelerates as the speed increases. When the absorbed energy is provided from kinetic energy of the vehicle, the vehicle is unintentionally decelerated. To prevent this, a control operation is performed so that the engine generates additional torque to generate energy.

Conversely, when the driving system speed decreases, the driving system needs to emit energy, the amount of which is proportional to equivalent inertia of a driving system element that decelerates as the speed decreases. When the absorbed energy is added to kinetic energy of the vehicle, the vehicle is unintentionally accelerated. To prevent this, a control operation is performed to offset the energy released by generating torque disconnection of the engine.

When virtually producing vibration or sound characteristics due to additional torque or torque disconnection generated by the engine in the EV to simulate the shift feeling generated through the present process, it is possible to use the fact that an intervention width is proportional to the equivalent inertia of the driving system element being accelerated and decelerated and the amount of acceleration and deceleration.

The torque effect proportional to the acceleration/deceleration width of the equivalent inertia of the driving system element may be expressed as Equation 1, which is a general driving system input/output torque equation.

Tₒᵤₜₚᵤₜ'Tᵢₙₚᵤₜ−J\dot{ω} [Equation 1]

Here, Tₒᵤₜₚᵤₜ denotes driving system input torque, Tᵢₙₚᵤₜ denotes driving system output torque, J denotes the equivalent inertia of the driving system, and \dot{ω} denotes angular acceleration, which is a differential value of the driving system speed.

In the above description, “intervention width” may refer to the amount of correction (the amount of addition/subtraction or the amount of intervention) by which the amplitude of the vibration or the sound volume is increased or decreased with respect to the basic amplitude or the basic sound volume so that vibration or sound characteristics simulating additional torque or torque disconnection generated by the engine may be virtually produced.

Assuming that the driving system equivalent inertia is a constant value, the magnitude of the virtual effect, that is, the volume of the virtual sound, may be set to be linked with the acceleration/deceleration width, and the present acceleration/deceleration width may be considered to correspond to the gradient of the virtual engine speed.

Therefore, when a state of performing virtual gear shifting is detected, a change rate of the virtual engine speed may be determined from a start time of virtual gear shifting, a value obtained by multiplying the determined change rate of the virtual engine speed by a preset gain value (which is the amount of correction of the sound volume) may be added to the basic sound volume, and the added value may be determined as a final sound volume value of the virtual sound.

When this is expressed as an equation, Equation 2 below is obtained.

$$Final sound volume = basic sound volume + \frac{d}{dt} ( virtual engine speed ) \times gain \qquad [ Equation 2 ]$$

Here, the basic sound volume may be the volume of the virtual sound in an existing virtual gear shifting function determined by a map from vehicle driving information obtained while virtual gear shifting is performed, that is, information indicating a vehicle driving state such as an accelerator pedal input value (APS value), a motor speed, a vehicle speed, etc. Alternatively, the basic sound volume may be the volume of the virtual sound, which is the magnitude of the existing virtual effect determined from the pressure of the tooth surface of the driving system gears.

In Equation 2, a preset value for each virtual type may be used as the gain, and a result obtained by multiplying the change rate of the virtual engine speed by the gain value corresponds to the amount of correction of the sound volume for correcting the basic sound volume of the virtual sound.

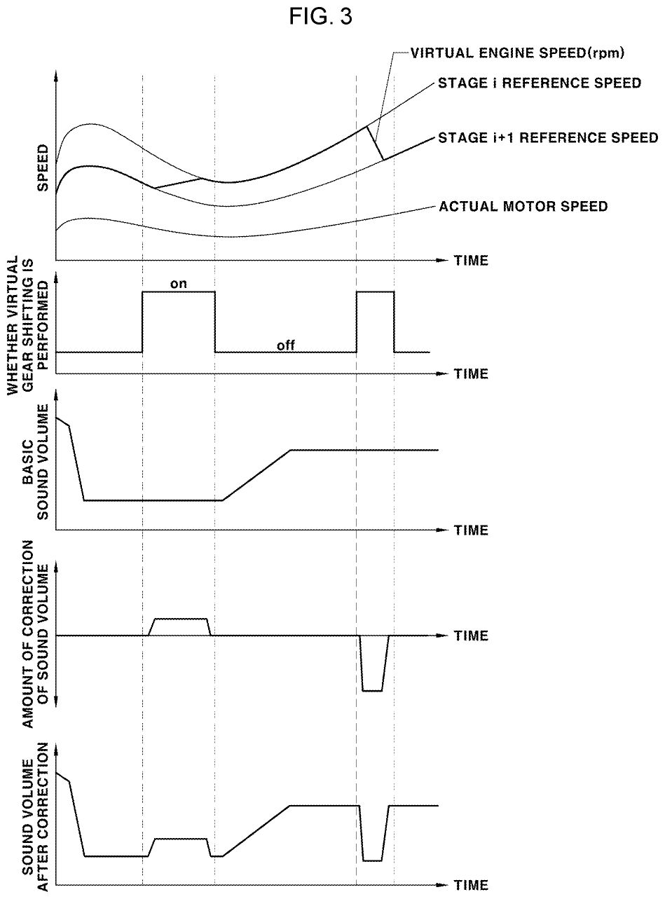

FIG. 3 is a diagram illustrating an exemplary embodiment of adjusting the volume of the virtual sound according to the virtual engine speed in various exemplary embodiments of the present disclosure, in which a horizontal axis represents time. Furthermore, a reference speed (rpm), an actual motor speed, and a virtual engine speed set for each shifting stage (stage i, stage i+1) are illustrated as diagrams on the upper side of the drawing.

Furthermore, FIG. 3 illustrates whether virtual gear shifting is performed while the vehicle is driven, “on” indicates a state in which virtual gear shifting is performed, and “off” indicates a state in which virtual gear shifting is not performed.

Furthermore, FIG. 3 illustrates information indicating the vehicle driving state, that is, the basic sound volume of the virtual sound determined from the vehicle driving information and the amount of correction of the sound volume determined as a value corresponding to a virtual engine speed change rate while virtual gear shifting is performed, and illustrates the sound volume obtained by correcting the basic sound volume by the amount of correction of the sound volume (“sound volume after correction”)

As illustrated in FIG. 3, in the case of downshift in which the shifting range is changed from stage i+1 (virtual current shifting stage) to stage i (virtual target shifting stage), sound volume increase correction is performed by adding the amount of correction of the sound volume, which is a positive (+) value, to the basic sound volume.

In the case of downshift in which the virtual engine speed increases, the virtual engine speed change rate is a positive (+) value, and thus the amount of correction of the sound volume becomes a positive (+) value. Therefore, when correction is performed by adding the amount of correction of the sound volume to the basic sound volume, the volume of the virtual sound is increased compared to the basic sound volume.

Conversely, in the case of upshift in which the shifting range is changed from stage i (virtual current shifting stage) to stage i+1 (virtual target shifting stage), sound volume decrease correction is performed by adding the amount of correction of the sound volume, which is a negative (−) value, to the basic sound volume.

In the case of upshift, in which the virtual engine speed decreases, the virtual engine speed change rate is a negative (−) value, and thus the amount of correction of the sound volume becomes a negative (−) value. Therefore, when correction is performed by adding the amount of correction of the sound volume to the basic sound volume, the volume of the virtual sound is decreased compared to the basic sound volume.

In the present way, after determining the gear shifting type (gear shifting class) based on the virtual current shifting stage (shifting stage before change) and the virtual target shifting stage (shifting stage after change), correction is performed by adding or subtracting the sound volume to or from the basic sound volume in accordance with whether upshift or downshift is performed.

As shown in FIG. 3, in the virtual effect production control unit 22 of the first controller 20, the amount of correction of the sound volume is determined as a negative (−) value in case of upshift, and the amount of correction of the sound volume is determined as a positive (+) value in case of downshift.

Furthermore, the amount of correction of the sound volume may be determined as a value corresponding to the change rate of the virtual engine speed, and the absolute value of the amount of correction of the sound volume may be increased as the change rate of the virtual engine speed increases. In the present instance, the change rate of the virtual engine speed and the amount of correction of the sound volume may be set to be proportional.

As a result, the virtual effect production control unit 22 of the first controller 20 outputs a command (sound effect command) for generating virtual sound including sound volume after correction as a virtual effect signal to the sound device 54. Accordingly, the sound device 54 is controlled so that the sound device 54 outputs virtual sound according to the command output by the virtual effect production control unit 22 of the first controller 20.

In an exemplary embodiment of the present disclosure, it is possible to output virtual vibration using the vibration device 51 separately from outputting virtual sound using the sound device 54, and the above description may be referred to in the case of a method of generating and implementing the virtual vibration by the vibration device 51.

In the above description, the virtual sound may be replaced with the virtual effect, and in the case of the method of generating and implementing virtual vibration by the vibration device 51, the virtual sound in the above description may be replaced with the virtual vibration, which is a virtual effect. Furthermore, in the above description, the sound volume may be referred to as the magnitude of the virtual effect, and may be replaced with the amplitude in the case of the virtual vibration.

Next, a description will be provided of an exemplary embodiment in which the magnitude of the virtual effect, for example, the volume of the virtual sound (or the amplitude of the virtual vibration) is adjusted based on the virtual gear shifting intervention torque.

As a method of determining the volume of the virtual sound, a method of determining the volume of the virtual sound linking with the virtual gear shifting intervention torque may be applied instead of the above-described sound volume increase/decrease method linking with the virtual engine speed change rate.

That is, the volume of the virtual sound is corrected by the amount of correction of the sound volume determined according to the virtual gear shifting intervention torque. In the present instance, it is possible to apply a method of correcting the basic sound volume of the existing virtual sound determined from the vehicle driving information by the amount of correction of the sound volume determined based on the virtual gear shifting type and the virtual gear shifting intervention torque. Here, the basic sound volume has been described above.

The virtual gear shifting intervention torque is configured to determine the final torque command so that the virtual shift feeling may be generated using the motor, which is the driving device 41, in implementing the virtual gear shifting function. At the instant time, the form of the virtual gear shifting intervention torque for generating and realizing the virtual shift feeling is generated to simulate the shift feeling of the vehicle including an actual transmission.

Here, considering that the shift feeling of the vehicle including the actual transmission is deeply related to the driving system acceleration/deceleration or driving system speed change rate (gradient) during shifting as described above, a method using the virtual gear shifting intervention torque may be a realistic sound volume adjustment (increase/decrease) and correction method.

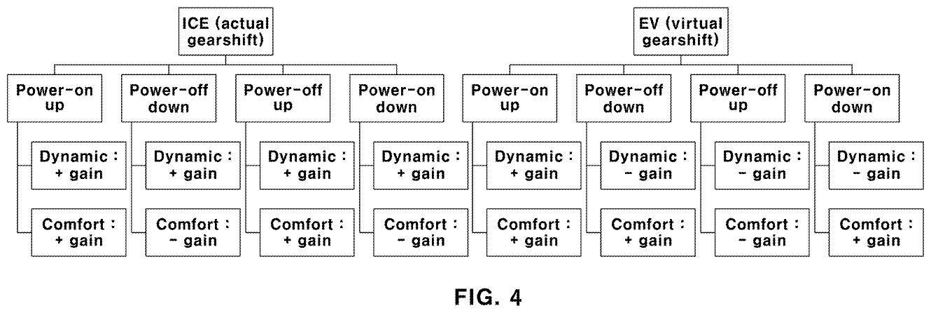

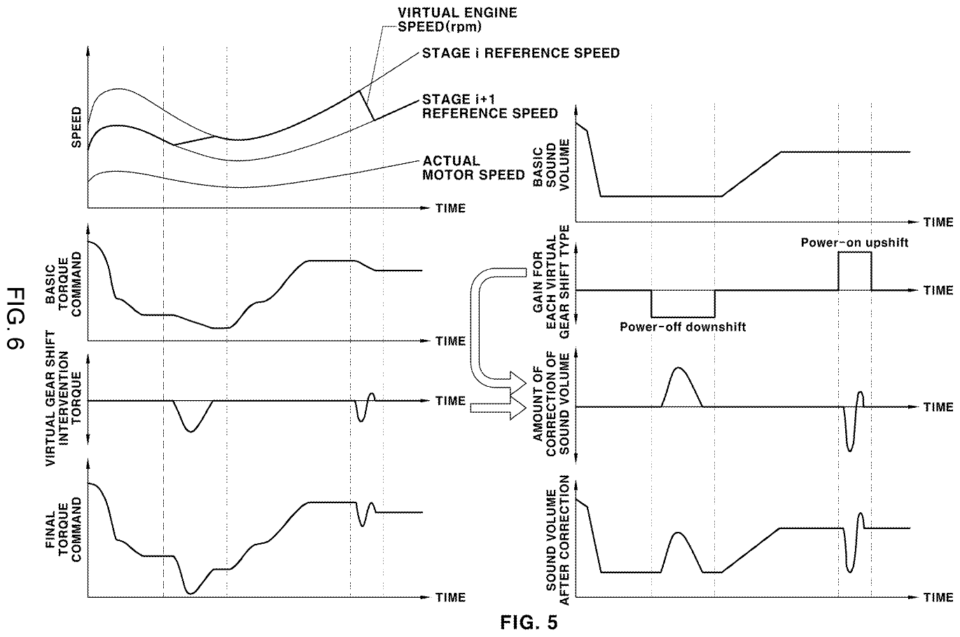

An exemplary embodiment of a method of adjusting the volume of the virtual sound based on the virtual gear shifting intervention torque may be described with reference to FIG. 4 and FIG. 5. The final torque command during virtual gear shifting may be corrected and generated by adding the virtual gear shifting intervention torque to the basic torque command.

In the present instance, a torque component combined to generate the virtual shift feeling is the virtual gear shifting intervention torque, and a value obtained by multiplying gain, which is obtained for each virtual gear shifting type (gear shifting class), by the present virtual gear shifting intervention torque may be determined as the amount of correction of the sound volume.

The gain may be determined as one of a positive (+) value and a negative (−) value according to the current shift type. To the present end, a gain value for each shift type illustrated in FIG. 4 may be previously set and stored in the virtual effect production control unit 22 of the first controller 20 and used.

Determining the shift type may be performed by determining the gear shifting class based on the above-described process of determining the gear shifting class, that is, the virtual current shifting stage and the virtual target shifting stage.

In various exemplary embodiments of the present disclosure, as illustrated in FIG. 4, the shift type may be determined as one of power-on and power-off and one of upshift and downshift.

When a method of setting and determining the gain is descried in more detail, the gain value may be set in consideration of a target intended by the virtual effect, the shift type, the vehicle type (ICE vehicle and EV), etc.

For example, in the case of power-off downshift, when a sporty and dynamic emission is to be produced in setting the virtual effect, a rev matching function may be set to be simulated. However, when a quiet and comfortable shift is to be simulated, the rev matching function should not be simulated.

Therefore, even in the case of the same power-off downshift, in the former case, the gain needs to be set so that the magnitude of the virtual effect, for example, the volume of the virtual sound instantaneously increases, and in the latter case, the gain needs to be set so that the magnitude of the virtual effect decreases.

However, in the method of varying the volume of virtual sound based on the form of the virtual gear shifting intervention torque, when the sound volume is target to be set to increase, in general, in the case of EV, the virtual gear shifting intervention torque may be a negative (−) value during power-off downshift, and thus the gain needs to be a negative (−) value. That is, both the shift intervention torque value and the gain value multiplied by each other needs to be negative (−) values so that the amount of correction of the sound volume may be determined as a positive (+) value.

However, in the case of the ICE vehicle, the shift intervention torque may be a positive (+) value, and thus the gain needs to be a positive (+) value because the use of the shift intervention torque is different between the ICE vehicle and the EV. Accordingly, the method of setting the gain value may vary according to the target of the virtual effect, the shift type, and the type of vehicle. A general gain setting method for each case is illustrated in FIG. 4.

For reference, a reason why the use of the shift intervention torque is different between the ICE vehicle and the EV will be briefly referred to as follows.

In the ICE vehicle, an actual transmission is present, and reaction force torque generated due to speed changes of rotational inertial elements of the engine and the driving system involved during shift affects acceleration and deceleration of the vehicle (shift shock occurs). Therefore, to alleviate the present phenomenon, the engine generates additional torque or performs correction to reduce previously generated torque. That is, the basic torque command determined based on the vehicle driving information is corrected by the shift intervention torque.

However, in the EV, even though shift torque is not generally generated due to the absence of a transmission, shift torque may be intentionally generated at an appropriate time to add an emotional factor. In the instant case, contrary to the case of the ICE vehicle, shift intervention torque is added to or subtracted from the motor torque to generate a shift shock.

FIG. 4 illustrates an example of setting a gain value for adjusting the magnitude of the virtual effect (for example, the sound volume) in the EV, and further illustrates a gain value assuming actual gear shifting of the ICE vehicle, which is not applied in an exemplary embodiment of the present disclosure and is unnecessary.

As illustrated in FIG. 4, in the EV to which an exemplary embodiment of the present disclosure is applied, as a virtual gear shifting mode, a dynamic mode for producing a relatively dynamic sensation and a comfort mode for producing a relatively comfortable sensation may be separately set.

At the present time, in the case of downshift, that is, in the case of power-on downshift and power-off downshift, the gain in the dynamic mode and the gain in the comfort mode may be set to opposite values of negative (−) and positive (+) values.

Referring to FIG. 4, in the case of the power-on downshift and the power-off downshift, it may be seen that the gain value of the dynamic mode is set to a negative (−) value, and the gain value of the comfort mode is set to a positive (+) value opposite to that of the dynamic mode.

Unlike the present case, in the case of the power-on upshift and the power-off upshift, as illustrated in FIG. 4, the dynamic mode and the comfort mode are not distinguished in the negative and positive gain values.

For example, in the case of the power-on upshift, the gain value may be set to a positive (+) value regardless of the mode, and in the case of power-off upshift, the gain value may be set to a negative (−) value regardless of the mode.

The dynamic mode and the comfort mode may be modes selected by the driver by operating the interface unit 11, or may be pre-set separately for a target vehicle to express a determined one of a dynamic characteristic and a comfort characteristic according to the vehicle or vehicle type before the vehicle is released.

FIG. 5 is a diagram illustrating an exemplary embodiment in which the magnitude of an acceleration effect is determined according to the virtual gear shifting intervention torque in an exemplary embodiment of the present disclosure, and a horizontal axis in each diagram represents time. FIG. 5 illustrates an example in which a virtual gear shifting of the power-on upshift is performed after the power-off downshift.

As described above, the basic torque command is a torque command determined based on the vehicle driving information, and the virtual gear shifting intervention torque is correction torque for correcting the basic torque command to generate and produce a virtual shift feeling by the motor, which is the driving device 41, during virtual gear shifting, and is torque determined by the virtual effect production control unit 22 of the first controller 20.

The virtual gear shifting intervention torque determined by the virtual effect production control unit 22 is input to the final torque command generation unit 23 of the first controller 20. At the instant time, the final torque command generation unit 23 corrects the basic torque command input from the basic torque command generation unit 21 of the first controller 20 by the virtual gear shifting intervention torque to generate a final motor command.

The exemplary embodiment of FIG. 5 is an exemplary embodiment in which virtual sound is generated and produced at the same time as generating and producing the virtual shift feeling by the motor. As described above, the final torque command may be determined as a value obtained by adding the virtual gear shifting intervention torque to the basic torque command, and the operation of the motor is controlled to generate a virtual shift feeling according to the final torque command determined as described above.

In FIG. 5, the basic sound volume has been described above. When the gain value for each virtual gear shifting type is obtained during virtual gear shifting, the virtual effect production control unit 22 of the first controller 20 is configured to determine a value obtained by multiplying the virtual gear shifting intervention torque by the gain as the amount of correction of the sound volume (“sound volume increase/decrease amount”).

Next, the virtual effect production control unit 22 is configured to perform sound volume correction of correcting the basic sound volume by the amount of correction of the sound volume. At the instant time, correction is performed to add the amount of correction of the sound volume to the basic sound volume.

Because the gain value is determined as one of a negative (−) or positive (+) value according to the virtual gear shifting type, the amount of correction of the sound volume over time has a negative (−) or positive (+) value. During correction of the sound volume, the basic sound volume is increased or decreased by the absolute value of the amount of correction of the sound volume. FIG. 5 illustrates the sound volume after correction of increase/decrease.

Accordingly, the virtual effect production control unit 22 of the first controller 20 outputs a command (sound effect command) for generating virtual sound including the sound volume after correction as a virtual effect signal to the sound device 54. Accordingly, the sound device 54 is controlled so that the sound device 54 outputs the virtual sound according to the command output by the virtual effect production control unit 22 of the first controller 20.

Next, an exemplary embodiment of determining the magnitude of the virtual effect based on a time-axis map will be described in detail.

The time-axis map is a map in which time is an independent variable, and may be used to determine the amount of correction of the magnitude of the virtual effect (for example, the amount of correction of the sound volume) by taking an elapsed time from the start of virtual gear shifting as input thereof while virtual gear shifting is performed.

The amount of correction of the magnitude of the virtual effect determined in the instant way may be used to correct the basic magnitude of the virtual effect while virtual gear shifting is being performed, or may be used as the magnitude of the virtual effect that replaces the basic magnitude as will be described later.

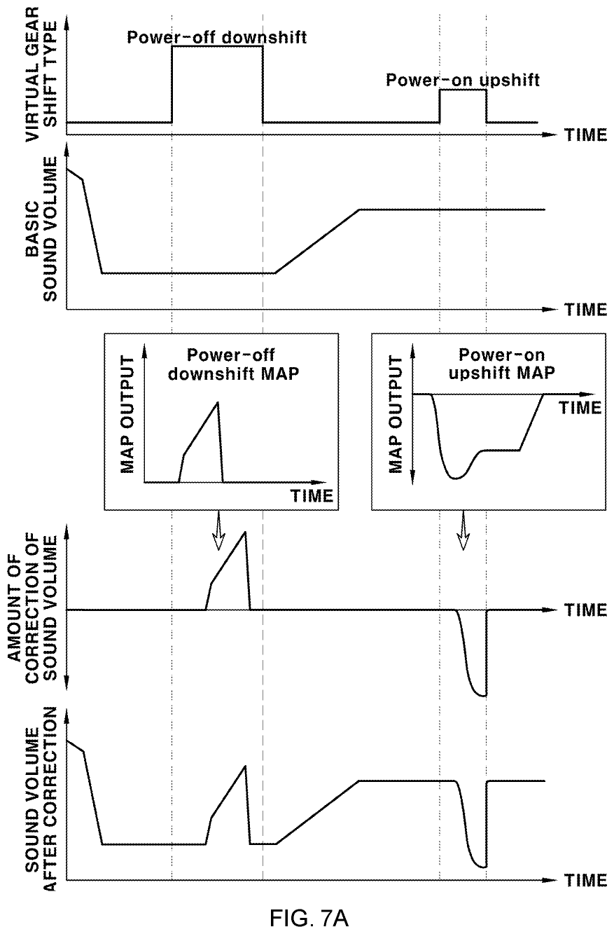

Hereinafter, an example of the virtual sound volume will be referred to as a virtual effect. FIG. 6 is a diagram illustrating a method of determining sound volume based on a time-axis map in an exemplary embodiment of the present disclosure, and illustrates that sound volume correction based on the time-axis map is performed during virtual gear shifting.

In the exemplary embodiment based on the time-axis map, the basic sound volume has been described above, and the amount of correction of the sound volume is generated and determined while virtual gear shifting is performed, and there is no difference from the exemplary embodiment of FIG. 5 in that the amount of correction of the sound volume may be used to correct the basic sound volume during virtual gear shifting.

Furthermore, there is no difference from the exemplary embodiment of FIG. 5 in that sound volume correction for adjusting the volume of the virtual sound is performed by adding the amount of correction of the sound volume generated while virtual gear shifting is performed to the basic sound volume.

As shown, the input of the time-axis map is time, and the time is a time starting from a virtual gear shifting start time point (virtual gear shifting stage change point), that is, a time elapsed from the virtual gear shifting start time point.

The output of the time-axis map is the amount of correction of the sound volume for increasing/decreasing and adjusting the basic sound volume during virtual gear shifting. That is, the time-axis map is a map in which the amount of correction of the sound volume that changes over time is set.

As described above, the time-axis map in which the amount of correction of the sound volume is set to a value according to time may be used so that the amount of correction of the sound volume corresponding to the current elapsed time may be determined in real time as time elapses from the virtual gear shifting start time point.

This time-axis map is used to determine the amount of correction of the sound volume in real time after virtual gear shifting starts while being input to and stored in the virtual effect production control unit 22 of the first controller 20 in advance.

Furthermore, when map output starts based on a shifting start signal in a process of determining the sound volume during virtual gear shifting, the virtual effect production control unit 22 of the first controller 20 corrects the basic sound volume in real time using the amount of correction of the sound volume, which is the map output, after shifting starts.

Furthermore, the virtual effect production control unit 22 of the first controller 20 outputs, to the sound device 54, a command (sound effect command) for generating the virtual sound of the sound volume after correction as a virtual effect signal. Accordingly, the sound device 54 is controlled so that the sound device 54 outputs the virtual sound according to the command output by the virtual effect production control unit 22 of the first controller 20.

Thereafter, the virtual effect production control unit 22 suspends output of the map at a time point when virtual gear shifting is completed, determines the basic sound volume as the final sound volume without correction of the sound volume from a time point of completion of shifting, and outputs a command for generating virtual sound of the final sound volume to the sound device 54. When virtual gear shifting is completed as described above, the operation of the sound device 54 is controlled so that the virtual sound is output as the basic sound volume without correction of the sound volume.

Even when a total time (all sections of input variables) for which the amount of correction of the sound volume is set in the time-axis map is longer than a time during virtual gear shifting, map output is forcibly terminated when virtual gear shifting is completed, and thus the volume of the virtual sound returns to the basic sound volume.

In the present way, until virtual gear shifting is completed, during virtual gear shifting, the amount of correction of the sound volume corresponding to the elapsed time starting from the virtual gear shifting start time point is extracted from the map in real time and used.

Furthermore, in the exemplary embodiment of the present disclosure, a plurality of time-axis maps set for each shift type may be used to determine the amount of correction of the sound volume during virtual gear shifting while being input to and stored in the virtual effect production control unit 22 of the first controller 20 in advance.

At the present time, the time-axis map corresponding to the current shift type is selected so that virtual sound according to the shift type may be generated and implemented, and the amount of correction of the sound volume corresponding to the current shift type is determined therefrom in real time during virtual gear shifting. Accordingly, differentiated sound volume correction may be performed according to the shift type, and it is possible to generate and implement virtual sound according to the shift type.

In the above description, it has been described that the sound volume of the virtual effect is adjusted by adding the amount of correction of the sound volume determined in real time by the map during virtual gear shifting to the basic sound volume as a negative (−) or positive (+) value.

However, instead of a method of adding the amount of correction of the sound volume to the basic sound volume, it is possible to apply a method of replacing the volume of the virtual sound with the amount of correction of the sound volume determined by the time-axis map only during virtual gear shifting. Alternatively, it is possible to apply a method of taking a minimum value or a maximum value of the basic sound volume and the amount of correction of the sound volume only during virtual gear shifting and determining the value as the volume of the virtual sound.

Furthermore, it has been described above that the map is differentiated for each virtual gear shifting type (for example, power-off downshift, power-on upshift, etc.), and the map corresponding to the current shift type is selected and used (see FIG. 6). However, it is possible to additionally differentiate the map based on at least one of each virtual gear shifting stage number during virtual gear shifting, each section of the accelerator pedal input value (APS value), each motor torque section, each driving system speed section, or each vehicle speed section in addition to the shift type.

Furthermore, instead of the additionally differentiated map as described above, it is possible to apply a method of multiplying a preset weight value or gain for each virtual gear shifting stage number during virtual gear shifting, each section of the accelerator pedal input value (APS value), each motor torque section, each driving system speed section, or each vehicle speed section by an output value of the time-axis map for each situation, and using the multiplied value as the final real-time amount of correction of the sound volume or the volume of the virtual sound replacing the basic sound volume.

Additionally, because a time from the virtual gear shifting start time point acts as an independent variable of the map, a discontinuity point between a map output value and a basic sound volume value may occur at a virtual gear shifting completion point.

In preparation therefor, when the volume of the virtual sound is forcibly returned to the basic sound volume at the virtual gear shifting completion point, sound volume gradient control may be applied. For example, the gradient of the returned sound volume may be limited by applying a preset gradient limit (rate limit).

As described above, in the exemplary embodiment based on the time-axis map, the virtual effect production control unit 22 of the first controller 20 outputs a command (sound effect command) for generating virtual sound including sound volume after correction as a virtual effect signal to the sound device 54. Accordingly, the sound device 54 is controlled so that the sound device 54 outputs virtual sound according to the command output by the virtual effect production control unit 22 of the first controller 20.

In an exemplary embodiment of the present disclosure, it is possible to output virtual vibration using the vibration device 51 separately from outputting virtual sound using the sound device 54, and the above description may be referred to in the case of a method of generating and implementing virtual vibration by the vibration device 51.

In the above description, the virtual sound may be replaced with a virtual effect, and in the case of the method of generating and implementing the virtual vibration by the vibration device 51, the virtual sound in the above description may be replaced with the virtual vibration, which is a virtual effect. Furthermore, in the above description, the sound volume may be regarded as the magnitude of the virtual effect, and may be replaced with the amplitude in the case of the virtual vibration.

Next, a detailed description will be provided of an exemplary embodiment of determining the magnitude of the virtual effect based on a map of the virtual gear shifting progress rate (shift progress).

The virtual gear shifting progress rate map is a map in which the virtual gear shifting progress rate (%) is set as an independent variable. While virtual gear shifting is performed, the virtual gear shifting progress rate may be used as input thereof to determine the amount of correction of the magnitude of the virtual effect (for example, the amount of correction of the sound volume). The amount of correction of the magnitude of the virtual effect determined in the instant way may be used to correct the basic magnitude of the virtual effect while virtual gear shifting is performed.

Furthermore, in various exemplary embodiments of the present disclosure, a plurality of virtual gear shifting progress rate maps set for each shift type may be used to determine the amount of correction of the sound volume during virtual gear shifting while being input to and stored in the virtual effect production control unit 22 of the first controller 20 in advance.

At the present time, the virtual gear shifting progress rate map corresponding to the current shift type is selected so that virtual sound according to the shift type may be generated and implemented, and the amount of correction of the sound volume corresponding to the current shift type is determined therefrom in real time during virtual gear shifting. Accordingly, differentiated sound volume correction may be performed according to the shift type, and it is possible to generate and implement virtual sound according to the shift type.

Hereinafter, a description will be provided of an example of virtual sound volume as a virtual effect. FIG. 7A and FIG. 7B are diagrams illustrating a method of determining sound volume based on the virtual gear shifting progress rate map in an exemplary embodiment of the present disclosure, and illustrate that sound volume correction based on the virtual gear shifting progress rate map is performed during virtual gear shifting.

In an exemplary embodiment based on the virtual gear shifting progress rate map, the basic sound volume has been described above. The amount of correction of the sound volume is generated and determined while virtual gear shifting is performed, and there is no difference from the exemplary embodiments of FIG. 5 and FIG. 6 in that the amount of correction of the sound volume may be used to correct the basic sound volume while virtual gear shifting is performed.

Furthermore, there is no difference from the exemplary embodiments of FIG. 5 and FIG. 6 in that sound volume correction for adjusting the volume of the virtual sound is performed by adding the amount of correction of the sound volume generated while virtual gear shifting is performed to the basic sound volume.

As shown, the input of the map is the virtual gear shifting progress rate (%), and the virtual gear shifting progress rate (%) is defined as described above. The output of the map is the amount of correction of the sound volume for increasing/decreasing and adjusting the basic sound volume during virtual gear shifting. That is, the virtual gear shifting progress rate map is a map in which the amount of correction of the sound volume that changes as the virtual gear shifting progress rate increases is set.

As described above, by use of the map in which the amount of correction of the sound volume is set to a value according to the virtual gear shifting progress rate (%), the amount of correction of the sound volume corresponding to a current virtual gear shifting progress rate may be determined in real time as the virtual gear shifting progress rate gradually increases from start of virtual gear shifting (virtual gear shifting progress rate 0%) to completion of virtual gear shifting (virtual gear shifting progress rate 100%).

In an exemplary embodiment based on the virtual gear shifting progress rate map, the amount of correction of the magnitude of the virtual effect, which is a map output value, is determined by a function of the virtual gear shifting progress rate (0% to 100%), and thus it is easy to determine an intended map output value at the virtual gear shifting start time point and the virtual gear shifting completion point. However, because the time axis is not an independent variable in the virtual gear shifting progress rate map, the form of the sound volume after actual correction may be distorted as the change rate of the virtual engine speed changes.

The virtual gear shifting progress rate map is used to determine the amount of correction of the sound volume in real time from start of virtual gear shifting (virtual gear shifting progress rate 0%) to completion of virtual gear shifting (virtual gear shifting progress rate 100%) while being input to and stored in the virtual effect production control unit 22 of the first controller 20 in advance.

Furthermore, in a process of determining the sound volume during virtual gear shifting, when map output starts from when the virtual gear shifting progress rate is 0% after virtual gear shifting starts, the virtual effect production control unit 22 of the first controller 20 corrects the basic sound volume in real time using the amount of correction of the sound volume, which is the map output, after shifting starts.

Furthermore, the virtual effect production control unit 22 of the first controller 20 outputs, to the sound device 54, a command (sound effect command) for generating virtual sound including sound volume after correction as a virtual effect signal. Accordingly, the sound device 54 is controlled so that the sound device 54 outputs virtual sound according to the command output by the virtual effect production control unit 22 of the first controller 20.

Thereafter, the virtual effect production control unit 22 suspends output of the map when the virtual gear shifting progress rate reaches 100%, determines the basic sound volume as the final sound volume without correction of the sound volume from completion of shifting, and outputs a command for generating virtual sound of the final sound volume to the sound device 54. When virtual gear shifting is completed as described above, the operation of the sound device 54 is controlled so that the virtual sound is output at the basic sound volume without sound volume correction.

Furthermore, in the exemplary embodiment of the present disclosure, a plurality of virtual gear shifting progress rate maps set for each shift type may be used to determine the amount of correction of the sound volume during virtual gear shifting while being input to and stored in the virtual effect production control unit 22 of the first controller 20 in advance.

At the present time, a virtual gear shifting progress rate map corresponding to a current shift type is selected so that virtual sound according to a shift type may be generated and implemented, and the amount of correction of the sound volume corresponding to the current shift type is determined therefrom in real time during virtual gear shifting. Thus, differentiated sound volume correction may be performed according to the shift type. Therefore, it is possible to generate and implement virtual sound according to the shift type.

FIG. 7A is a diagram illustrating an example of determining a virtual gear shifting progress rate. A method of determining the virtual gear shifting progress rate will be described in more detail. The virtual gear shifting progress rate may be determined at predetermined intervals until virtual gear shifting is completed (virtual gear shifting progress rate 100%) based on a real-time virtual engine speed while virtual gear shifting is performed after the start of virtual gear shifting (virtual gear shifting progress rate 0%) in the virtual effect production control unit 23 of the first controller 20.

First, after determining a difference value between a reference speed of a virtual current shifting stage and a reference speed of a virtual target shifting stage based on a time point when virtual gear shifting starts, a value obtained by dividing the difference value by a change rate (gradient) of the virtual engine speed is determined as a total estimated required time (TimeTot) until completion of virtual gear shifting.

In the present way, the estimated required time determined from the time point when virtual gear shifting starts becomes the total estimated time required from the start of virtual gear shifting until completion of virtual gear shifting.

Subsequently, the above determination process is repeatedly performed at predetermined intervals. A remaining estimated required time (TimeRem) until completion of virtual gear shifting is continuously determined at predetermined intervals until a reference vehicle of the virtual target shifting stage is reached from a current virtual engine speed based on the virtual engine speed that varies in real time.

The remaining estimated required time is determined in the present way. At the same time, until virtual gear shifting is completed, the virtual gear shifting progress rate (%) may be determined as Equation 3 below using the remaining estimated required time determined at the predetermined intervals and the total estimated required time determined at the virtual gear shifting start time point.

Virtual gear shifting progress rate=[(TimeTot−TimeRem)/TimeTot]×100 [Equation 3]

In Equation 3, TimeTot denotes the total estimated required time determined at the virtual gear shifting start time point, and TimeRem denotes the remaining estimated required time until the virtual gear shifting completion point determined based on the real-time virtual engine speed until virtual gear shifting is completed.

FIG. 7B illustrates a virtual gear shifting progress rate map different for each shift type, and illustrates a virtual gear shifting progress rate map during power-off downshift and a virtual gear shifting progress rate map during power-on upshift.

After virtual gear shifting starts and until virtual gear shifting is completed, as the virtual gear shifting progress rate (%) increases, the amount of correction of the sound volume (map output value) corresponding to a current virtual gear shifting progress rate is determined on the virtual gear shifting progress rate map, and sound volume is determined after correcting the amount of correction of the sound volume determined in real time to a value added to the basic sound volume at the same time.

As a result, in the exemplary embodiment based on the virtual gear shifting progress rate map, the virtual effect production control unit 22 of the first controller 20 outputs a command (sound effect command) for generating virtual sound including sound volume after correction as a virtual effect signal to the sound device 54. Accordingly, the sound device 54 is controlled so that the sound device 54 outputs virtual sound according to the command output by the virtual effect production control unit 22 of the first controller 20.

In an exemplary embodiment of the present disclosure, it is possible to output virtual vibration using the vibration device 51 separately from outputting virtual sound using the sound device 54, and the above description may be referred to in the case of a method of generating and implementing virtual vibration by the vibration device 51.

In the above description, the virtual sound may be replaced with the virtual effect, and in the case of the method of generating and implementing virtual vibration by the vibration device 51, the virtual sound may be replaced with virtual vibration, which is a virtual effect, in the above description. Furthermore, in the above description, the sound volume may be regarded as the magnitude of the virtual effect, and may be replaced with the amplitude in the case of the virtual vibration.

Accordingly, according to the method of implementing characteristics of the ICE vehicle in the EV according to an exemplary embodiment of the present disclosure, characteristics of the driving system of the ICE vehicle may be generated and provided through vibration and sound in the EV not provided with the ICE (engine), the transmission, the clutch, etc., and it is possible to provide the driver with a feeling of operation and a feeling of driving as if the actual ICE, transmission, and clutch operate in the EV.

Furthermore, the driver may feel driving sensation, fun, thrill, a direct connection feeling, etc. provided by the driving system of the ICE vehicle in the vehicle of the driver without the need to change to the ICE vehicle.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of implementing characteristics of an internal combustion engine (ICE) vehicle in an electric vehicle (EV), the method comprising:
determining, by a controller, a virtual gear shifting type based on vehicle driving information obtained during vehicle driving and starting virtual gear shifting;
determining, by the controller, a magnitude of a virtual effect based on vehicle driving information obtained while the virtual gear shifting is performed;
determining, by the controller, an amount of correction of the magnitude of the virtual effect based on the determined virtual gear shifting type and state information related to the virtual gear shifting while the virtual gear shifting is performed;
correcting, by the controller, the determined magnitude of the virtual effect by the determined amount of correction of the magnitude of the virtual effect while the virtual gear shifting is performed; and
generating and outputting, by the controller, a virtual effect signal including the corrected magnitude of the virtual effect, and controlling an operation of a virtual effect generation device according to the output virtual effect signal so that a virtual effect including the corrected magnitude is generated in a vehicle.

2. The method of claim 1,
wherein the virtual effect includes a virtual sound simulating sound generated while shifting is performed in the ICE vehicle,
wherein the virtual effect generation device includes a sound device configured to generate and output virtual sound in the vehicle, and
wherein the magnitude of the virtual effect includes a volume of the virtual sound.

3. The method of claim 1,
wherein the virtual effect includes virtual vibration simulating vibration generated while shifting is performed in the ICE vehicle,
wherein the virtual effect generation device includes a vibration device configured to generate and output virtual vibration in the vehicle, and
wherein a magnitude of the virtual effect includes an amplitude of the virtual vibration.

4. The method of claim 1, wherein the correcting of the magnitude of the virtual effect includes adding an amount of correction of the magnitude of the virtual effect to magnitude before correction of the determined virtual effect, and determining a sum thereof as the corrected magnitude of the virtual effect.

5. The method of claim 1, wherein the virtual gear shifting type includes a power-off downshift, a power-on upshift, a power-off upshift, and a power-on downshift.

6. The method of claim 1,
wherein the state information related to the virtual gear shifting includes a virtual engine speed determined from a driving system speed of the vehicle detected by a sensor, and
wherein the determining of the amount of correction of the magnitude of the virtual effect includes determining the amount of correction of the magnitude of the virtual effect based on the virtual gear shifting type and a change rate of the virtual engine speed.

7. The method of claim 6, wherein, in the determining of the amount of correction of the magnitude of the virtual effect:
a value obtained by multiplying the change rate of the virtual engine speed by a gain value is determined; and
the gain value is a preset value determined according to the virtual gear shifting type.

8. The method of claim 7, wherein the amount of correction of the magnitude of the virtual effect is:
determined as a negative (−) value when the virtual gear shifting type is an upshift; and
determined as a positive (+) value when the virtual gear shifting type is a downshift.

9. The method of claim 1,
wherein the state information related to the virtual gear shifting includes virtual gear shifting intervention torque, which is correction torque for generating a virtual shift feeling by a motor driving the vehicle, and
wherein the determining of the amount of correction of the magnitude of the virtual effect includes determining the amount of correction of the magnitude of the virtual effect based on the virtual gear shifting type and the virtual gear shifting intervention torque.

10. The method of claim 9, wherein, in the determining of the amount of correction of the magnitude of the virtual effect:
a value obtained by multiplying the virtual gear shifting intervention torque by a gain value is determined; and
the gain value is a preset value determined according to the virtual gear shifting type.

11. The method of claim 10,
wherein a dynamic mode producing a relatively dynamic sensation and a comfort mode producing a relatively comfortable sensation are set as virtual gear shifting modes in the controller, and
wherein in the controller, when the virtual gear shifting type includes a power-on downshift and a power-off downshift,
a gain value in the dynamic mode is set to a negative (−) value, and
a gain value in the comfort mode is set to a positive (+) value.

12. The method of claim 10, wherein in the controller,
when the virtual gear shifting type is a power-on downshift, gain values in the dynamic mode and the comfort mode are set to positive (+) values; and
when the virtual gear shifting type is a power-off upshift, gain values in the dynamic mode and the comfort mode are set to negative (−) values.

13. The method of claim 9, further including:
determining, by the controller, a basic torque command for the motor driving the vehicle based on the vehicle driving information obtained during vehicle driving;
determining, by the controller, a final torque command obtained by adding the virtual gear shifting intervention torque to the basic torque command while the virtual gear shifting is performed; and
controlling, by the controller, an operation of the motor according to the final torque command.

14. The method of claim 13,
wherein the virtual effect includes a virtual sound simulating sound generated while shifting is performed in the ICE vehicle,
wherein the virtual effect generation device includes a sound device configured to generate and output virtual sound in the vehicle, and
wherein the magnitude of the virtual effect includes a volume of the virtual sound.

15. The method of claim 1,
wherein the state information related to the virtual gear shifting is an elapsed time from a start time point of the virtual gear shifting; and
in the determining of the amount of correction of the magnitude of the virtual effect, a time-axis map for each of virtual gear shifting types is used in which time is set as an independent variable and an amount of correction of the magnitude of the virtual effect is set in advance as a value according to the time, which is the independent variable, and the amount of correction of the magnitude of the virtual effect is determined from a time-axis map corresponding to a current virtual gear shifting type by taking the elapsed time from the start time point of the virtual gear shifting as input thereof while the virtual gear shifting is performed.

16. The method of claim 15, wherein
after a time point when the virtual gear shifting is completed,
output of the time-axis map is forcibly terminated, and
the magnitude of the virtual effect is determined as magnitude determined based on the vehicle driving information, which is uncorrected magnitude, and a virtual effect signal including the uncorrected magnitude is generated and output to control an operation of the virtual effect generation device.

17. The method of claim 1,
wherein the state information related to the virtual gear shifting includes a virtual gear shifting progress rate (%) determined in real time from a start time point of the virtual gear shifting as a starting point; and
wherein in the determining of the amount of correction of the magnitude of the virtual effect,
a virtual gear shifting progress rate map for each of virtual gear shifting types is used in which the amount of correction of the magnitude of the virtual effect is set in advance as a value according to the virtual gear shifting progress rate, and
the amount of correction of the magnitude of the virtual effect is determined from a virtual gear shifting progress rate map corresponding to a current virtual gear shifting type by taking the virtual gear shifting progress rate as input thereof while the virtual gear shifting is performed.

18. A non-transitory computer readable storage medium on which a program for performing the method of claim 1 is recorded.

19. An apparatus of implementing characteristics of an internal combustion engine (ICE) vehicle in an electric vehicle (EV), the apparatus comprising:
a virtual effect generation device:
a processor; and
a non-transitory storage medium containing program instructions,
wherein the processor is configured of, by executing the program instructions:
determining a virtual gear shifting type based on vehicle driving information obtained during vehicle driving and starting virtual gear shifting;
determining a magnitude of a virtual effect based on vehicle driving information obtained while the virtual gear shifting is performed;
determining an amount of correction of the magnitude of the virtual effect based on the determined virtual gear shifting type and state information related to the virtual gear shifting while the virtual gear shifting is performed;
correcting the determined magnitude of the virtual effect by the determined amount of correction of the magnitude of the virtual effect while the virtual gear shifting is performed; and
generating and outputting a virtual effect signal including the corrected magnitude of the virtual effect, and controlling an operation of the virtual effect generation device according to the output virtual effect signal so that a virtual effect including the corrected magnitude is generated in a vehicle.
